(19) United States
(12) Patent Application Publication
(10) Pub. No.: US 2008/0023943 A1
(43) Pub. Date: Jan. 31, 2008

(54) CUSHION OF AIR BAG APPARATUS

(75) Inventor: Hae Wook Kwon, Kyungki-do (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Yongin-shi (KR)

(21) Appl. No.: 11/561,697

(22) Filed: Nov. 20, 2006

(30) Foreign Application Priority Data
Jul. 25, 2006 (KR) 10-2006-0069984

(51) Int. Cl. B60R 21/16

(52) U.S. Cl. 280/728.2

(57) ABSTRACT

A cushion of an airbag apparatus includes a cushion body having a gas inflow portion in a rear portion thereof such that gas from an inflator flows thereinto and the cushion is deployed toward a passenger upon collision of a vehicle, a gas fluid guide mounted in inside of the cushion body to guide the gas fluid flowing through the gas inflow portion of the cushion body in left and right directions, and a cushion deployment guide mounted in external of the cushion body to restrict front deployment of the cushion body upon initial deployment of the cushion body and, simultaneously to guide deployment of the cushion body in the left and right directions.

This application claims the benefit of Korean Patent Application No. 10-2006-0069984 filed on Jul. 25, 2006, which is hereby incorporated by reference for all purposes as if fully set forth herein.

### BACKGROUND OF THE INVENTION

1. Field of the Invention

The invention relates generally to the cushion of an airbag apparatus for absorbing impact on vehicle occupants upon collision accident of a vehicle and, more particularly, to the cushion of an airbag apparatus for minimizing injury to passengers which are in an abnormal seat state.

2. Description of the Background Art

Generally, an air-bag apparatus is installed inside a vehicle in order to protect seated in a vehicle occupant seated in an operator seat or a passenger seat from impact.

As the airbag apparatus, there are an operator side airbag apparatus, a passenger side airbag apparatus and a lateral airbag apparatus. The operator side airbag apparatus is mounted in an handle and protects the front of a operator seated in an operator seat, the passenger side airbag apparatus is mounted in an instrument panel and protects the front of a passenger seated in a passenger seat, and the lateral airbag apparatus is mounted in the side of a seat and protects the side of a vehicle occupant.

Meanwhile, the airbag apparatus includes an inflator which emits gas upon the collision accident of a vehicle, a cushion which is deployed toward a passenger due to the gas from the inflator, thereby absorbing impact to a passenger, and an airbag housing in which the cushion and the inflator are received and which is mounted in the inside of the vehicle.

In the above-described airbag apparatus, the gas emitted from the inflator flows into the inside of the cushion upon the collision accident of the vehicle, and the cushion is deployed toward the passenger owing to the pressure of the gas, thereby protecting the passenger from the impact due to the collision of the vehicle.

In this case, a gas inflow portion through which the gas from the inflator flows is formed in the opposite side of the passenger of the cushion, and one or more tether for controlling the deployment of the cushion is provided in the inside of the cushion.

However, with the cushion of a conventional airbag apparatus, when a passenger is in an out-of-position state in which the passenger is seated in the seat of a vehicle at an abnormal position, there are problems in that a deployed cushion does not protect the passenger and the passenger is more injured due to the deployment pressure of the cushion.

Therefore, with a current airbag apparatus, a passenger detection sensor is installed in the inside of a vehicle, so that a cushion is not deployed or be in a Low Risk Deployment (LRD) when a passenger is determined to be in the out-of-position state by the passenger detection sensor, thereby minimizing damage to the passenger.

As a method of implementing the LRD of the cushion, there are a method of decreasing the gas pressure of the inflator, a method of emitting gas flowing into the cushion to the outside upon initial deployment, and a method of restricting the initial deployment of the cushion using a separate structure.

However, when the gas pressure of the inflator is reduced, or the gas flowing into the cushion is emitted to the outside, there is a problem in that the protection performance of the airbag apparatus for the passenger, which is normally seated, is reduced.

Furthermore, when a plurality of flaps are arranged to be folded in a structure wrapping the exterior of the cushion in order to the initial deployment of the cushion, the initial deployment is delayed due to the frictional resistance between the flaps, but there are problems in that it is difficult to uniformly design the performance of an airbag apparatus because the frictional resistance between the flaps are not uniform, and it is complicated to arrange the plurality of flaps to be folded in the exterior of the cushion.

In particular, currently, there is a tendency to make a regulation related to the performance of an airbag apparatus in order to protect a passenger, which is in a out-of-position state. Therefore, the performance of an airbag apparatus for the out-of-position state of an infant under 1 year of age, a toddler under 3 years of age or a child under 6 years of age is required and there is disadvantage when the required performance is not satisfied.

### SUMMARY

Accordingly, an object of the present invention has been made keeping in mind the above problems occurring in the prior art, and an object of the present invention is to provides the cushion of an airbag apparatus which is constructed to guide the fluid direction of gas flowing into the cushion to be left and right directions and to guide the deployment direction of the cushion in the left and right directions upon the initial deployment of the cushion, thereby minimizing damage to a passenger which is in an out-of-position state and to acquire the protection performance for a passenger which is normally seated. Furthermore, another object of the present invention is to sufficiently acquire the performance of an airbag apparatus for the out-of-position state of an infant under 1 year of age, a toddler under 3 years of age or a child under 6 years of age and to reduce the number of elements, cost and weight of the airbag apparatus.

The present invention provides a cushion of an airbag apparatus, including a cushion body having a gas inflow portion in a rear portion thereof such that gas from an inflator flows thereinto and the cushion is deployed toward a passenger upon collision of a vehicle; gas fluid guiding means mounted in inside of the cushion body to guide the gas fluid flowing through the gas inflow portion of the cushion body in left and right directions; and cushion deployment guiding means mounted in external of the cushion body to restrict front deployment of the cushion body upon initial deployment of the cushion body and, simultaneously to guide deployment of the cushion body in the left and right directions.

In this case, the gas fluid guiding means includs an inner chamber strap, both ends of which are connected to inner surface of a rear portion of the cushion body so as to be respectively arranged in upper and lower portions of the gas inflow portion and central portion of which is arranged to be bent in front of the gas inflow portion.

A tether, which has one end coupled to the gas fluid guiding means and another end coupled to the inner surface of front portion of the cushion body, is provided inside the cushion body. Alternatively, a tether, which has one end coupled to the inner surface of the rear portion of the cushion body and another end coupled to the inner surface of front portion of the cushion body, may be provided inside the cushion body.

Furthermore, the cushion deployment guiding means includes an outer tether strap formed to wrap the external surface of the cushion body in upper and lower directions.

On the cushion deployment guiding means, a tear line is formed so as to be torn and be removed when a deployment pressure of the cushion body increases to be higher than a predetermined value.

The cushion body is constructed such that the gas inflow portion is engaged and fixed between a retainer and the airbag housing, and the cushion deployment guiding means such that both ends thereof are engaged and fixed between a retainer and the airbag housing along with the cushion body.

### BRIEF DESCRIPTION OF THE DRAWINGS

The invention will be described in detail with reference to the following drawings in which like numerals refer to like elements. The accompany drawings, which are included to provide a further understanding of the invention and are incorporated in and constitute a part of this specification, illustrate embodiments of the invention and together with the description serve to explain the principles of the invention. In the drawings:

FIG. 1 is an exploded perspective view illustrating a passenger side air bag apparatus having a cushion according to the present invention.

FIG. 2 is a sectional view illustrating the passenger side air bag apparatus having a cushion according to the present invention.

FIG. 3 is a side cross sectional view illustrating the deployment state of the cushion according to the embodiment of the present invention.

FIG. 4 is a perspective view illustrating the deployment state of the cushion according to the embodiment of the present invention.

FIG. 5 is an operational state diagram illustrating the internal state of the cushion at the time of initial deployment of a passenger side airbag apparatus according to an embodiment of the present invention.

FIG. 6 is an operational state diagram illustrating the external state of the cushion at the time of initial deployment of a passenger side airbag apparatus according to an embodiment of the present invention.

FIG, 7 is a side cross sectional view illustrating the deployment state of a cushion according to another embodiment of the present invention.

### DETAILED DESCRIPTION OF PREFERRED EMBODIMENTS

Preferred embodiments of the present invention will be described in a more detailed manner with reference to the drawings. Reference will now be made in detail to embodiments of the present invention, examples of which are illustrated in the accompanying drawings.

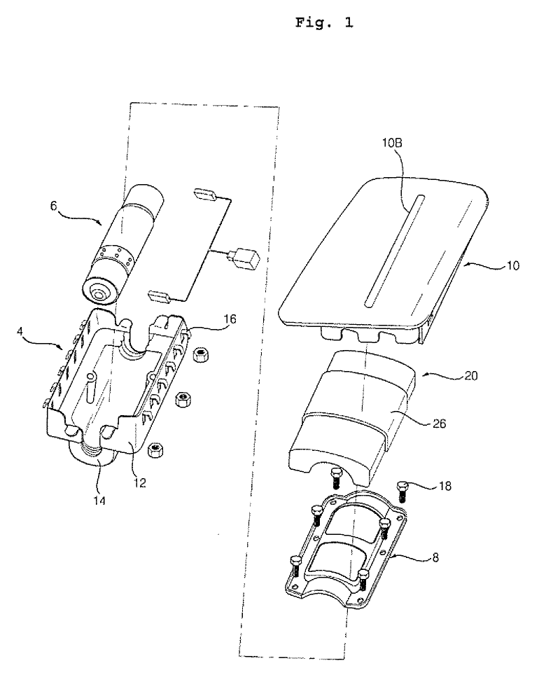

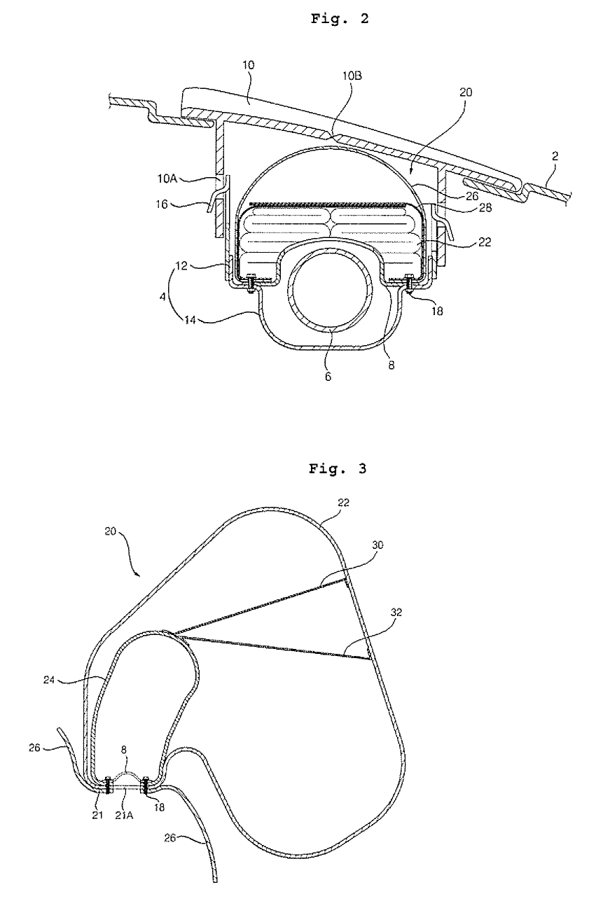

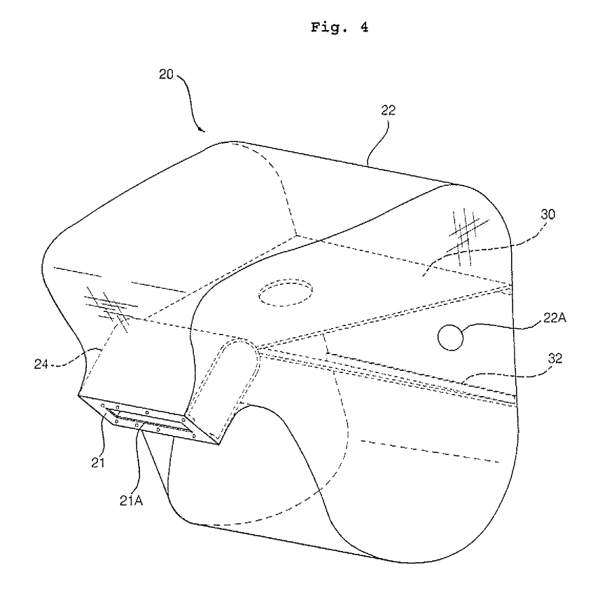

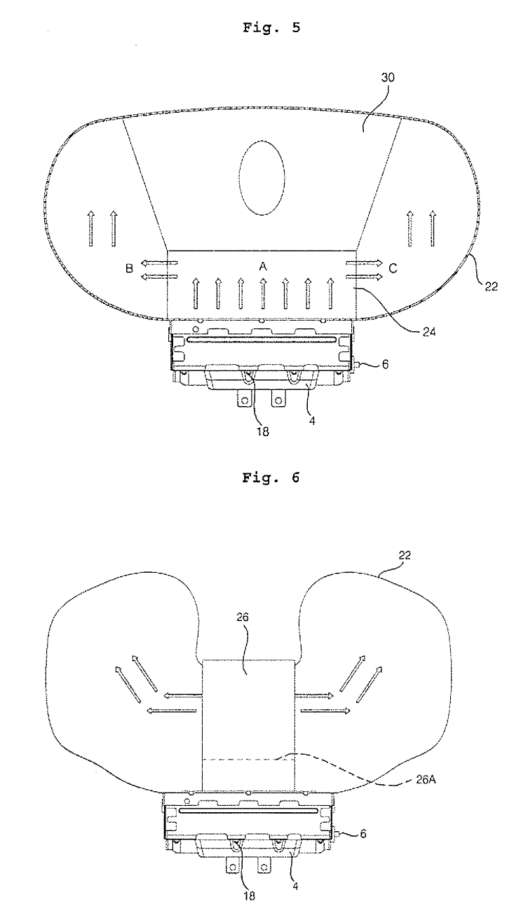

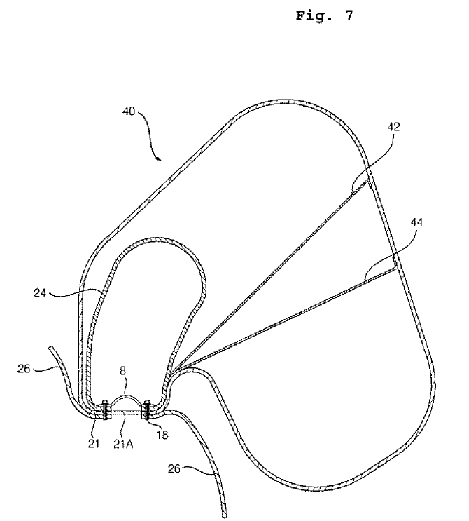

FIG. 1 and FIG. 2 are an exploded perspective view and a sectional view illustrating a passenger side air bag apparatus having a cushion according to the present invention, FIGS. 3 and 4 are a side cross sectional view and a perspective view illustrating the deployment state of the cushion according to the embodiment of the present invention. FIGS. 5 and 6 are operational state diagrams illustrating the internal state and external state of the cushion at the time of initial deployment of a passenger side airbag apparatus according to an embodiment of the present invention.

FIG. 6 is an operational state diagram illustrating the outer state of the cushion at the time of initial deployment of a passenger side airbag apparatus according to an embodiment of the present invention.

The passenger side air bag apparatus according to the present invention includes, as illustrated in FIG. 1 to FIG. 6, an air bag housing 4 installed in an instrument panel 2, an inflator 6 installed in the air bag housing 4 and for emitting gas upon collision of a vehicle, an retainer 8 installed and fixed in the inside of the air bag housing 4 and having a plurality of holes formed therein for emitting the gas of the inflator 6, an air bag door 10 installed in the entire front surface opened of the air bag housing 4 and arranged in the hole of the instrument panel 2, and a cushion 20 received in the inside of the airbag housing 4 so as to break the airbag door 10 due to the gas flowing through the hole of the retainer 8 and to be deployed toward a passenger seat.

The air bag housing 4 includes a cushion housing 12 which is installed in the rear surface of the instrument panel 2 and in the inside of which the cushion 20 is received, and a can housing 14 which is installed in the rear portion of the cushion housing 12 and in which the inflator 6 is received.

A hook 16, which is engaged with a hook hole 10A formed in the side of the air bag door 10, is formed on the outer surface of the cushion housing 12, and a mounting bracket (not shown) is formed on one side of the can housing 14 and is fixed to a cowl cross member (not shown) using a bolt.

The inflator 6 is connected to a collision detection sensor (not shown) for detecting the collision of a vehicle and is exploded by a signal from the collision detection sensor upon collision of a vehicle. Due to the pressure of the gas, the cushion is deployed toward the front of the cushion housing 12.

The cushion 20 is received to be folded within the airbag housing 4, in the rear portion of which a gas inflow portion 21, through which the gas of the inflator 6 flows, is formed and is engaged and fixed to the airbag housing 4 by the retainer 8 using an engagement member 18.

Therefore, in the passenger air bag apparatus, when the collision detection sensor detects the collision of the vehicle, the inflator 6 is exploded by the signal from the collision detection sensor, thereby emitting gas. The gas of the inflator 6 passes through the air bag housing 4 and then flows into the inside of the cushion 20 through the holes of the retainer 8, thereby deploying the cushion 20. Furthermore, the cushion 20 breaks a dissection line formed on the airbag door 10 and is then deployed toward the front of the passenger seated in a passenger seat, thereby absorbing the impact of the passenger.

Meanwhile, the cushion according to an embodiment of the present invention includes a cushion body 22 on the rear portion of which the gas flowing part 21 is formed such that the gas from the inflator 6 flows into the cushion and then the cushion is deployed toward the vehicle occupant upon collision of the vehicle, a gas fluid guiding part 24 which is mounted in the inside of the cushion body 22 to guide gas fluid flowing through the gas flowing part 21 of the cushion body 22 in right and left directions, a cushion deployment guiding means 26 which is mounted in the outside of the cushion body 22 to restrict the front deployment of the cushion body 22 and, at the same time, to guide the deployment of the cushion body 22 in left and right directions.

The cushion body 22 is a member made of textile material which is deployed by the gas from the inflator 6 upon collision of a vehicle and then protects a passenger seated in a passenger seat from impact, and is folded and received in the inside of the airbag housing 4 in various structures, on the outer surface of which a cushion cover 28 wrapping the cushion body 22 is prepared.

The gas inflow portion 21 is fixed between the retainer 8 and the airbag housing 4, in which an inflow hole 21A is formed to be through the hole of the retainer 8.

Bent holes 22A for emitting the gas inside the cushion body 22 to the outside are respectively formed in the both sides of the cushion body 22. Each of the bent holes 22A has a structure to prevent the internal gas pressure of the cushion body 22 from excessively increasing and, at the same time, to reliably absorb impact while the cushion body 22 is relaxed due to the weight of a passenger.

The gas fluid guiding means 24 is a guiding member made of textile material which changes the flowing direction of gas flowing through the inflow hole 21A of the gas inflow portion 21 into the left and right directions of the cushion body 22, and is constructed of an inner chamber strap, the both ends of which are connected to the upper portion and lower portion of the gas inflow portion 21, and the central portion of which is arranged in the front of the gas inflow portion 21.

The inner chamber strap 24 is a member shaped in a strip which is formed to have a width identical to that of the gas inflow portion 21. The both ends thereof which respectively are arranged in the upper portion and the lower portion of the gas inflow portion 21 are mounted in the inner surface of the cushion body 22 using sewing, and the central portion which is arranged in the front of the gas inflow portion 21 is bent in a half circle.

That is, the inner chamber strap 24 is opened in the left and right directions of the cushion body 22 and the side of the gas inflow portion 22, thereby performing the role of a fluid through which enables the gas flowing into the gas inflow portion 21 to flow in the left and right directions of the cushion body 22.

The inner chamber strap 24 is formed to be bent in an ‘U’ shape.

Meanwhile, tethers 30 and 32 are prepared between the inner chamber strap 24 and the cushion body 22. Each of the tethers 30 and 32 has an end coupled to the central portion of the inner chamber strap 24 and another end coupled to the inner surface of the front portion of the cushion body 22 and controls the deployment shape of the cushion body 22.

If required, a plurality of tethers may be provided in the inside of the cushion body 22.

The cushion deployment guiding means 26 is a guiding member made of textile material which restricts front deployment upon initial deployment of the cushion body 22 and, at the same time, guides the deployment in the left and right directions, and is constructed of an outer chamber strap, which is arranged to wrap the outer surface of the cushion body 22 in upper and lower directions and the both ends of which are fixed between the retainer 8 and the airbag housing 4.

The outer tether strap 26 is a member shaped in a strip which is formed to have a width less than that of the cushion body 22, and is arranged to wrap the upper surface, front surface and lower surface of the cushion body 22, the both ends of which are fixed to the airbag housing 4 by the retainer 8 along with the gas inflow portion 21 of the cushion body 22.

A tear line 26A which is removed while being torn by the cushion body 22 when the deployment pressure of the cushion body 22 increases to be higher than a predetermined value is formed in one side of the outer tether strap 26.

That is, the outer tether strap 26 functions to acquire the protection performance of the airbag apparatus even in an out-of-position state by restricting the front deployment of the cushion body 22 when the initial deployment pressure of the cushion body 22 is less than the predetermined value.

The outer tether strap 26 is formed in a ‘C’ shape in which the rear portion thereof is opened such that the cushion body 22 is received therein.

The operation and effect of the cushion of the passenger side airbag apparatus according to the present invention constructed as described above are described below.

First, when the collision of a vehicle is detected by the collision detection sensor and delivers an operation signal to the inflator 6, the inflator 6 is exploded and generates gas. The gas travels along the airbag housing 4, and flows into the gas inflow portion 21 of the cushion body 22 through the hole of the retainer 8.

Thereafter, the gas A flows into the inside of the cushion body 22 through the inflow hole 21A of the gas inflow portion 21.

As described above, the gas flowing into the inside of the cushion body 22 flows into the inside of the inner chamber strap 24, and then travels along the inner surface of the central portion of the inner chamber strap 24 in the left and right directions B and C of the cushion body 22.

Therefore, since the gas from the inflator 6 is supplied to the inside of the cushion body 22 while the fluid direction thereof is changed into the left and right directions by the inner chamber strap 24, the front deployment pressure of the cushion body 22 decreases and the left and right deployment pressures increase, so that the initial front deployment pressure of the cushion body 22 decreases upon initial deployment of the cushion 20, thereby improving the protection performance of the airbag apparatus even in the out-of-position state.

Furthermore, the cushion body 22 is sufficiently deployed in the left and right directions by the gas of the inflator 6 at the time of initial deployment of the cushion 20, so that a problem in which the cushion body 22 is not entirely deployed and deployed toward the front thereof is resolved, thus improving the deployment performance of the cushion 20.

When the gas of the inflator 6 is continuously supplied to the inside of the cushion body 22, the inner pressure of the cushion body 22 increases, thereby realizing expansion. However, the front deployment of the cushion body 22 is again restricted by the outer tether strap 26 mounted in the outer surface of the cushion body 22.

That is, the outer tether strap 26 wraps the outer surface of the cushion body 22 in upper and lower directions, so that the front deployment of the cushion body 22 is restricted, thereby the deployment being achieved in the left and right directions.

Therefore, the deployment direction of the cushion body 22 is restricted to be the left and right directions by the outer tether strap 26, so that the front deployment pressure of the cushion body 22 is not delivered to a passenger at the time of initial deployment of the cushion 20, thereby improving the protection performance of the airbag apparatus even in the out-of-position state, and the cushion body 22 is deployed in the left and right directions upon initial deployment, thereby improving the deployment performance of the cushion 20.

Meanwhile, when the gas of the inflator 6 is further supplied to the inside of the cushion body 22, and then the inner pressure of the cushion body 22 increases to be higher than the predetermined value, the outer tether strap 26 is torn along the tear line 26A by the deployment pressure of the cushion body 22 and then is removed from the outer surface of the cushion body 22.

When the outer tether strap 26 is removed, the cushion body 22 is finally deployed toward the front thereof, breaks the dissection line 10B of the airbag door 10 and is then deployed toward the front of a passenger seated in the passenger seat.

FIG. 7 is a side cross sectional view illustrating the deployment state of a cushion according to another embodiment of the present invention.

For reference, same references are added to components similar to those of the construction of the above-described embodiment and descriptions thereof are omitted.

The cushion 40 of the airbag apparatus according to another embodiment of the present invention includes tethers 42 and 44 inside a cushion body 22 as illustrated in FIG. 7. One end of each of the tethers 42 and 44 is coupled to the inner surface of the rear portion of the cushion body 22 and another end of each of the tethers 42 and 44 is coupled to the inner surface of the front portion of the cushion body 22. The remaining features thereof are identical to those of the above-described embodiment.

If required, a plurality of tethers may be provided in the inside of the cushion body 22.

Therefore, in the cushion 20 of this embodiment, stress acting on the tethers 42 and 44 upon deployment of the cushion body 22 is not delivered to the inner chamber strap 24, so that there is an advantage in that the structural strength of the inner chamber strap 24 can be lower than that of the above-described embodiment.

Although the cushion of an airbag apparatus according to the present invention is describe with reference to embodiments shown in the drawings, it is noted that the present invention is not restricted by the embodiments and the drawings and various modifications are possible within the technical scope of the present invention by those skilled in the art.

That is, the gas fluid guiding means is not limited to the inner chamber strap, and may be formed in a pocket shape.

Furthermore, the cushion deployment guiding means is not limited to the outer chamber strap, and may be formed of a plurality of wires.

In the cushion of the airbag apparatus according to the present invention constructed as described above, the fluid direction of gas flowing into the inside of the cushion body by the gas fluid guiding means mounted in the inside of the cushion body is guided in the left and right directions, and the front deployment of the cushion body is restricted by the cushion deployment guiding means mounted in the outer of the cushion body and, at the same time, deployment in left and right directions is guided, so that the low risk deployment of the cushion body is implemented by the gas fluid guiding means and the cushion guiding means, thereby there being advantageous to minimize damage to a passenger which is an out-of-position state and to sufficiently acquire the protection performance for a passenger which is normally seated.

Furthermore, the airbag apparatus having the cushion satisfies a regulation for low risk deployment under all test conditions for an infant under 1 year of age, a toddler under 3 years of age or a child under 6 years of age at the time of performance tests in an out-of-position state, so that there is an advantage in that disadvantages in sales are prevented upon sale of the airbag apparatus.

Furthermore, the protection performance of the airbag apparatus for an abnormal seated state and a normal seated state can be acquired using the cushion, so that there is advantageous to eliminate a passenger detection sensor and a plurality of flaps required for a conventional airbag apparatus, thereby reducing the number of elements, cost and weight of the airbag apparatus.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A cushion of an airbag apparatus, comprising:
a cushion body having a gas inflow portion in a rear portion thereof such that gas from an inflator flows thereinto and the cushion is deployed toward a passenger upon collision of a vehicle;
a gas fluid guide mounted in inside of the cushion body to guide the gas fluid flowing through the gas inflow portion of the cushion body in left and right directions; and
a cushion deployment guide mounted in external of the cushion body to restrict front deployment of the cushion body upon initial deployment of the cushion body and, simultaneously to guide deployment of the cushion body in the left and right directions.

2. The cushion as set forth in claim 1, wherein the gas fluid guide comprises an inner chamber strap, both ends of which are connected to inner surface of a rear portion of the cushion body so as to be respectively arranged in upper and lower portions of the gas inflow portion and central portion of which is arranged to be bent in front of the gas inflow portion.

3. The cushion as set forth in claim 2, further comprising a tether inside the cushion body which has one end coupled to the gas fluid guide and another end coupled to the inner surface of front portion of the cushion body.

4. The cushion as set forth in claim 2, further comprising a tether inside the cushion body which has one end coupled to the inner surface of the rear portion of the cushion body and another end coupled to the inner surface of front portion of the cushion body.

5. The cushion as set forth in claim 1, wherein the cushion deployment guide comprises an outer tether strap formed to wrap the external surface of the cushion body in upper and lower directions.

6. The cushion as set forth in claim 5, wherein, on the cushion deployment guide, a tear line is formed so as to be torn and be removed when a deployment pressure of the cushion body increases to be higher than a predetermined value.

7. The cushion as set forth in claim 5, wherein:
the cushion body is constructed such that the gas inflow portion is engaged and fixed between a retainer and the airbag housing; and
the cushion deployment guide such that both ends thereof are engaged and fixed between a retainer and the airbag housing along with the cushion body.

8. The cushion as set forth in claim 1, further comprising a tether inside the cushion body which has one end coupled to the gas fluid guide and another end coupled to the inner surface of front portion of the cushion body.

9. The cushion as set forth in claim 1, further comprising a tether inside the cushion body which has one end coupled to the inner surface of the rear portion of the cushion body and another end coupled to the inner surface of front portion of the cushion body.

10. The cushion as set forth in claim 1, wherein, on the cushion deployment guide, a tear line is formed so as to be torn and be removed when a deployment pressure of the cushion body increases to be higher than a predetermined value.

11. The cushion as set forth in claim 1, wherein:
the cushion body is constructed such that the gas inflow portion is engaged and fixed between a retainer and the airbag housing; and
the cushion deployment guide is configured such that both ends thereof are engaged and fixed between a retainer and the airbag housing along with the cushion body.
